(19) United States
(12) Patent Application Publication
(10) Pub. No.: US 2025/0377123 A1
(43) Pub. Date: Dec. 11, 2025

(54) APPARATUS AND METHOD FOR CONTROLLING AN ORIFICE OF A TESTING DEVICE FOR PERFORMING A LEAKAGE TEST

(71) Applicant: Aeroseal LLC, Miamisburg, OH (US)

(72) Inventors: Sachin Kumar Koyeti, Miamisburg, OH (US); Ethan James Shepherd, Miamisburg, OH (US)

(21) Appl. No.: 18/797,635

(22) Filed: Aug. 8, 2024

Related U.S. Application Data
(60) Provisional application No. 63/657,503, filed on Jun. 7, 2024.

(51) Int. Cl. F24F 11/32; F24F 11/52; G01F 1/42

(52) U.S. Cl. CPC F24F 11/32; F24F 11/52; G01F 1/42

(57) ABSTRACT

An apparatus for controlling an orifice of a testing device is provided. The apparatus obtains test data associated with an enclosure. The test data includes one or more observation values associated with one or more predefined orifice settings of the testing device, and a predefined target pressure. The apparatus further calculates flow range data for each of the one or more predefined orifice settings based on the one or more observation values and determines device flow data for each of the one or more predefined orifice settings based on the flow range data. The apparatus further determines target flow data for the enclosure based on the device flow data and the predefined target pressure and identifies an orifice setting from the one or more predefined orifice settings. The apparatus further controls a setting of the orifice based on the identified orifice setting for performing the leakage test.

### TECHNICAL FIELD

The present disclosure generally relates to heating ventilation and air conditioning (HVAC) systems, and more particularly relates to an apparatus and a method for controlling an orifice of a testing device for performing a leakage test associated with the HVAC systems.

### BACKGROUND

Air leakage testing is a critical process for evaluating the energy efficiency and structural integrity of HVAC systems and building envelopes. The primary objective of an air leakage test is to accurately measure a rate of air infiltration and exfiltration, an indoor air quality, and an overall building performance. For example, the rate of air infiltration and exfiltration may significantly impact heating and cooling efficiency of HVAC systems. To this end, air leakage tests provide a comprehensive evaluation of airtightness of a building envelope (referred to as an enclosure, hereinafter), thereby allowing identifying and addressing areas of concern. By quantifying the rate of air infiltration and exfiltration, building owners and managers may make informed decisions about a need for air sealing, insulation upgrades, or other energy-efficiency measures.

There are various methods known for detecting leaks in HVAC systems, which can be broadly categorized into push-through and pull-through systems. Additionally, these methods range from relatively simple solutions to those that utilize sensitive electronics. Typically, leakage tests involve determining a pressure versus flow characteristics of an enclosure under test. One common approach is to use a pressure drop across a flow sensor to determine a flow of air through the enclosure being tested.

The flow sensor is a critical component in the leakage testing process for HVAC systems. By measuring the pressure differential across the flow sensor, leakage test methods can be used to determine a volumetric flow rate and detect potential air leaks. To perform leakage tests accurately across a wide range of enclosure dimensions, multiple flow sensors of varying sizes may be used. This ensures that the pressure drop can be measured within an acceptable range, providing reliable data for the analysis of the leakage tests.

To ensure that a leakage test is performed accurately and efficiently, a test environment needs to be properly maintained. This involves achieving a target pressure within the enclosure using a testing device, such as a fan. To reach the target pressure and provide sufficient flow measurement accuracy, an appropriate orifice setting of the testing device must be selected from multiple available orifice settings. For example, a choice of the orifice setting of the testing device may significantly impact a quality and reliability of results.

Despite the effectiveness of conventional leakage testing methods, they have significant limitations. Typically, a selection of an ideal orifice setting of the testing device for air leakage testing depend on a manual, trial-and-error approach. Technicians must individually test each available orifice setting to identify the most suitable one for efficiently conducting the leakage assessment. This hands-on process of evaluating each option separately could be labor-intensive, cumbersome, time-consuming, and may require significant expertise of the technicians, ultimately reducing the overall effectiveness of the testing procedure.

When an inappropriate orifice setting is chosen, it can result in inaccurate leakage test results, which may continue to result in energy inefficiencies in the HVAC systems. For example, inaccuracies in this selection process can lead to suboptimal decision-making regarding air sealing, insulation upgrades, or other energy-efficiency measures. This can result in wasted resources, inefficient building performance, and potential health and safety risks for building occupants.

Therefore, given the limitations and potential consequences associated with the manual selection of the appropriate orifice setting for air leakage testing, there is a need to overcome these problems and improve the accuracy and efficiency of the leakage testing process.

### SUMMARY

In order to solve the foregoing problems, the present disclosure may provide an apparatus, a method and a computer programmable product for performing an air leakage test accurately. The techniques disclosed in the present disclosure enable automated adjustment of a setting of an orifice for performing the leakage test and provide a more efficient, accurate, and reliable solution for determining the appropriate orifice setting.

An apparatus, a method and a computer programmable product are provided for controlling an orifice of a testing device for performing a leakage test.

In one aspect, an apparatus for controlling an orifice of a testing device for performing a leakage test is disclosed. The apparatus may include a memory configured to store computer executable instructions, and one or more processors configured to execute the instructions to obtain test data associated with an enclosure. The test data may include one or more observation values associated with one or more predefined orifice settings of the testing device, and a predefined target pressure for performing the leakage test. The one or more processors may further be configured to calculate flow range data for each of the one or more predefined orifice settings based on the one or more observation values and determine device flow data for each of the one or more predefined orifice settings based on the flow range data. The device flow data may include a minimum device flow and a maximum device flow for each of the one or more predefined orifice settings. The one or more processors may further be configured to determine target flow data for the enclosure based on the device flow data and the predefined target pressure and identify an orifice setting from the one or more predefined orifice settings for performing the leakage test based on the device flow data and the target flow data. The one or more processors may further be configured to cause to control, using a controller, a setting of the orifice of the testing device based on the identified orifice setting for performing the leakage test.

In additional apparatus embodiments, the one or more processors may further be configured to generate simulation data for each of the one or more predefined orifice settings based on the flow range data, the device flow data, and the target flow data and predict, using a first model, a flow range for each of the one or more predefined orifice settings based on the corresponding simulation data. The one or more processors may further be configured to iteratively compare the flow range for each of the one or more predefined orifice settings with target flow data to determine an intersection and identify the orifice setting from the one or more predefined orifice settings for performing the leakage test based on the intersection.

In additional apparatus embodiments, the one or more processors may further be configured to determine one or more leakage parameters associated with the enclosure based on the test data and determine the device flow data for each of the one or more predefined orifice settings of the testing device based on the one or more leakage parameters.

In additional apparatus embodiments, the testing device may be a fan operable to supply air through the identified orifice setting from the one or more predefined orifice settings to the enclosure for performing the leakage test.

In additional apparatus embodiments, the test data may further include at least one of pressure differential data associated with the enclosure, flow vs pressure data associated with the enclosure, one or more enclosure parameters, orifice pressure vs flow data for each of the one or more predefined orifice settings, orifice characteristics of the one or more predefined orifice settings, or testing device characteristics.

In additional apparatus embodiments, the flow range data may include at least one of maximum air flow data associated with each of the one or more predefined orifice settings, or calibrated flow range data for each of the one or more predefined orifice settings.

In additional apparatus embodiments, the one or more processors may further be configured to generate a recommendation for the leakage test based on the identified orifice setting.

In additional apparatus embodiments, the one or more processors may further be configured to display, via a user interface, the generated recommendation.

In additional apparatus embodiments, the one or more processors may further be configured to receive a user input via the user interface. The user input may be associated with performing the leakage test and identify the orifice setting from the one or more predefined orifice settings for performing the leakage test based on the user input.

In additional apparatus embodiments, the one or more processors may further be configured to the obtain environmental data associated with the enclosure and determine the device flow data for each of the one or more predefined orifice settings based on the environmental data.

In additional apparatus embodiments, the one or more observation values may include at least one of an orifice flow coefficient (k₀), an orifice flow exponent (n₀), a leakage flow coefficient (k₁), a leakage flow exponent (n₁), and a fan curve (f).

In another aspect, a method for controlling an orifice of a testing device for performing a leakage test is disclosed. The method may include obtaining test data associated with an enclosure. The test data may include one or more observation values associated with one or more predefined orifice settings of the testing device, and a predefined target pressure for performing the leakage test. The method may further include calculating flow range data for each of the one or more predefined orifice settings based on the one or more observation values and determining device flow data for each of the one or more predefined orifice settings based on the flow range data. The device flow data may include a minimum device flow and a maximum device flow for each of the one or more predefined orifice settings. The method may further include determining target flow data for the enclosure based on the device flow data and the predefined target pressure and identifying an orifice setting from the one or more predefined orifice settings for performing the leakage test based on the device flow data and the target flow data. The method may further include causing to control, using a controller, a setting of the orifice of the testing device based on the identified orifice setting for performing the leakage test.

In additional method embodiments, the method may further include generating simulation data for each of the one or more predefined orifice settings based on the flow range data, the device flow data, and the target flow data and predicting, using a first model, a flow range for each of the one or more predefined orifice settings based on the corresponding simulation data. The method may further include iteratively comparing the flow range for each of the one or more predefined orifice settings with target flow data to determine an intersection and identifying the orifice setting from the one or more predefined orifice settings for performing the leakage test based on the intersection.

In additional method embodiments, the method may further include determining one or more leakage parameters associated with the enclosure based on the test data and determining the device flow data for each of the one or more predefined orifice settings of the testing device based on the one or more leakage parameters.

In additional method embodiments, the testing device may be a fan operable to supply air through the identified orifice setting from the one or more predefined orifice settings to the enclosure for performing the leakage test.

In additional method embodiments, the test data may further include at least one of pressure differential data associated with the enclosure, flow vs pressure data associated with the enclosure, one or more enclosure parameters, orifice pressure vs flow data for each of the one or more predefined orifice settings, orifice characteristics of the one or more predefined orifice settings, or testing device characteristics.

In additional method embodiments, the flow range data may include at least one of maximum air flow data associated with each of the one or more predefined orifice settings, or calibrated flow range data for each of the one or more predefined orifice settings.

In additional method embodiments, the method may further include generating a recommendation for the leakage test based on the identified orifice setting.

In additional method embodiments, the one or more observation values may include at least one of an orifice flow coefficient (k₀), an orifice flow exponent (n₀), a leakage flow coefficient (k₁), a leakage flow exponent (n₁), and a fan curve (f).

In yet another aspect, a computer programmable product for controlling an orifice of a testing device for performing a leakage test is disclosed. The computer programmable product may include a non-transitory computer readable medium having stored thereon computer executable instructions, which when executed by one or more processors, cause the one or more processors to carry out operations including obtaining test data associated with an enclosure. The test data may include one or more observation values associated with one or more predefined orifice settings of the testing device, and a predefined target pressure for performing the leakage test. The operations may further include calculating flow range data for each of the one or more predefined orifice settings based on the one or more observation values and determining device flow data for each of the one or more predefined orifice settings based on the flow range data. The device flow data may include a minimum device flow and a maximum device flow for each of the one or more predefined orifice settings. The operations may further include determining target flow data for the enclosure based on the device flow data and the predefined target pressure and identifying an orifice setting from the one or more predefined orifice settings for performing the leakage test based on the device flow data and the target flow data. The operations may further include causing to control, using a controller, a setting of the orifice of the testing device based on the identified orifice setting for performing the leakage test.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a block diagram of a network environment in which an apparatus for controlling an orifice of a testing device for performing a leakage test is implemented, in accordance with one or more embodiments of the present disclosure;

FIG. 2 illustrates an exemplary block diagram of the apparatus of FIG. 1, in accordance with an example embodiment of the present disclosure;

FIG. 3 is a flowchart that illustrates an exemplary method for identifying an ideal setting of an orifice of the testing device of FIG. 1, in accordance with an example embodiment of the present disclosure;

FIG. 4A illustrates an exemplary block diagram of the testing device, in accordance with an example embodiment of the present disclosure;

FIG. 4B illustrates a cross-sectional view of the testing device, in accordance with an example embodiment of the present disclosure;

FIG. 5A illustrates exemplary operations for determining device flow data for each of one or more predefined orifice settings of the testing device, in accordance with an example embodiment of the present disclosure;

FIG. 5B is a diagram that illustrates exemplary operations for controlling an orifice of the testing device, in accordance with an example embodiment of the present disclosure;

FIG. 6 is a diagram that illustrates an exemplary method for determining device flow data for each of one or more predefined orifice settings of the testing device, in accordance with an example embodiment of the present disclosure;

FIG. 7A is a diagram that illustrates exemplary operations for recommending an orifice setting of the testing device, in accordance with an example embodiment of the present disclosure;

FIG. 7B is a diagram that illustrates exemplary operations for orifice setting identification for performing a leakage test, in accordance with an example embodiment of the present disclosure; and

FIG. 8 is a flowchart that illustrates an exemplary method for controlling an orifice of a testing device for performing a leakage test, in accordance with an example embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

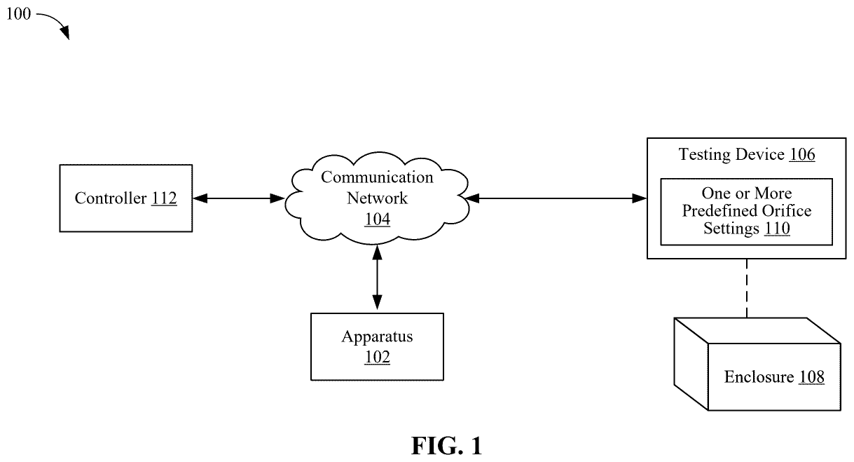

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 8, a brief description concerning the various components of the present disclosure will now be briefly discussed. Reference will be made to the figures showing various embodiments of an apparatus for determining an orifice setting of a testing device for performing an air leakage test.

Conventionally, the determination of an appropriate orifice setting relied heavily on a manual selection process. A technician had to manually test each of the multiple orifice settings to determine which one would be most suitable for performing the leakage test efficiently. This manual selection process of testing each orifice setting individually was labor-intensive, cumbersome, time consuming and required significant expertise, which is used to reduce the overall efficiency of the testing procedure.

Various embodiments are provided herein for controlling an orifice of a testing device for performing leakage tests, enabling accurate performance and output of the leakage tests The provided embodiments also enable automated adjustment of an orifice plate of the testing device which reduces the time and effort required to determine the appropriate setting, and automatically controls the orifice of the testing device for performing the leakage tests accurately. The automated adjustment of the orifice of the testing device aims to provide an ideal orifice setting for reliable air leakage measurements.

Further, the ideal orifice setting may even be tailored to specific test conditions, which further leads to improving overall test effectiveness. This further enhances the adaptability of air leakage testing. The ideal orifice setting enhances the reliability and performance of products and systems by ensuring an accurate air leakage test thereby solving the problems related to inaccurate air leakage tests.

Embodiments of the present disclosure may provide an apparatus, a method and a computer programmable product for controlling an orifice of a testing device for performing a leakage test. The present disclosure ensures accurate measurement of the air leakage in HVAC systems and building envelopes (referred to as enclosures) by automating orifice selection. By improving the precision of the air leakage measurement, the overall performance and reliability of the HVAC system and energy efficiency of building envelopes are enhanced.

FIG. 1 illustrates a block diagram of a network environment 100 in which an apparatus 102 for controlling an orifice of a testing device 106 for performing a leakage test is implemented, in accordance with one or more embodiments of the present disclosure. With reference to FIG. 1, there is shown a diagram of the network environment 100. The network environment 100 includes the apparatus 102, a communication network 104, the testing device 106 and a controller 112. The testing device 106 may be connected to an enclosure 108. Further, the testing device 106 may include one or more predefined orifice settings 110 of an orifice.

The apparatus 102 may include suitable logic, circuitry, interfaces, and/or code that may be configured to control the orifice of testing device 106 for performing a leakage test. Specifically, the apparatus 102 may be configured to control a setting of the orifice of the testing device 106 for performing the air leakage test. Examples of the apparatus 102 may include, but are not limited to, an electronic control unit (ECU), an electronic control module (ECM), a computing device, a mainframe machine, a server, a computer workstation, any and/or any other device.

In another example embodiment, the apparatus 102 may be embodied as a cloud-based service, a cloud-based application, a cloud-based platform, a remote server-based service, a remote server-based application, a remote server-based platform, or a virtual computing system. In yet another example embodiment, the apparatus 102 may be an OEM (Original Equipment Manufacturer) cloud.

The communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The testing device 106 may correspond to a testing equipment kit for performing leakage tests. The testing device 106 may be used to perform air leakage tests in HVAC systems and building envelops. In an example, the testing device 106 may include a fan which may be responsible for generating the necessary airflow for the leakage test. In an embodiment, the testing device 106 is the fan operable to supply air through an identified orifice setting from one or more predefined orifice settings 110 to the enclosure 108 for performing the leakage test. The fan's operation is characterized by its fan curve, which delineates a relationship between airflow rate and pressure differential, allowing precise control of pressure levels within a test environment, i.e., the enclosure 108.

In an embodiment, the network environment 100 may include one or more pressure sensors. The one or more pressure sensors may be arranged within the enclosure 108. The one or more pressure sensors are used for obtaining accurate pressure readings of fan pressure, duct pressure and reference pressure to determine a differential pressure. In an example embodiment, the network environment 100 may include one or more flow sensors. The one or more pressure sensors may be arranged within the enclosure 108 and/or in association with the testing device. The flow sensors are used for obtaining the flow characteristics associated with the enclosure 108 for determining pressure vs flow characteristics for performing precise leakage tests.

It may be noted that throughout the present disclosure, the terms “leakage test” and “air leakage test” are used interchangeably. The leakage test or the air leakage test is performed to check if the enclosure 108 has an air leak therein. In this regard, air is supplied through the testing device 106 to check if a flow of the air throughout the enclosure 108 is desirable or not. Based on the results of the air leakage test indicating, for example, flow of the air and/or pressure of the air across the enclosure 108, a determination is made whether the air leak is present or not.

The testing device 106 includes one or more orifice plates, where each of the one or more orifice plates may have distinct flow coefficients and exponents. The one or more orifice plates are configured to create a pressure drop, facilitating a measurement of airflow rates. The testing device 106 further includes one or more predefined orifice settings 110 of each of the one or more orifice plates for performing the air leakage test. For example, adjusting an orifice plate at a particular orifice setting may allow control of an amount of air or fluid supplied to the enclosure 108 through the testing device 106.

The enclosure 108 may correspond to a duct of an HVAC system. The enclosure 108 serves as a conduit for conditioned air for heating or cooling, and to circulate throughout living spaces. In an example, the enclosure 108 may be a duct or a conduit connecting the HVAC system to a space which is to be conditioned. In this case, the enclosure 108 may be a type of sheet metal ducts, where these ducts are made from galvanized steel or aluminum, and are unlikely to harbor mold. The enclosure 108 may further be a type of flex ducts. In another example, the enclosure 108 may be a summation of the duct as well as the space which is to be conditioned.

The controller 112 may be embodied as a device or a component for sending and receiving electronic signals for controlling a configuration of the one or more orifice plates of the testing device 106. The controller 112 may receive an input signal from the apparatus 102 and accordingly generate an output signal to control a setting of the orifice of the testing device 106 for performing the leakage test. Examples of the controller 112 may include, one of but not limited to, a programmable logic controller (PLC), a microcontroller, a sensor-based controller, an electronic control unit (ECU), an electronic control module (ECM), a computing device, a server, or/and any other device.

In operation, the apparatus 102 may be configured to obtain test data associated with the enclosure 108. The test data may include one or more observation values associated with one or more predefined orifice settings 110 of the testing device 106, and a predefined target pressure for performing the leakage test. The one or more observation values may correspond to one or more testing parameters of the orifice plates of the testing device 106 or the testing parameters of the enclosure 108 for performing the leakage test. The predefined target pressure may refer to an optimal pressure, that needs to be maintained in the enclosure 108 for accurately performing the leakage test.

In an exemplary embodiment, the apparatus 102 is configured to receive pressure differentials across the enclosure 108 and testing device 106. The pressure differentials may be received from the one or more pressure sensors arranged within the enclosure 108. In another exemplary embodiment, the apparatus 102 may be configured to receive flow sensor orifice characteristics of the one or more predefined orifice settings 110 of the orifice of the testing device 106.

Thereafter, in an embodiment, the apparatus 102 is configured to calculate flow range data for each of the one or more predefined orifice settings 110 based on the one or more observation values. The flow range data may be calculated based on a calculation of a maximum air flow (Q_{Max}) through each of the one or more predefined orifice settings 110 and a calculation of calibrated flow range data for each of the one or more predefined orifice settings 110. The calibrated flow range data may include a calibrated flow range [Q_{0Min}, Q_{0Max}] for each of the one or more predefined orifice settings 110.

For instance, the calibration process ensures that each of the one or more predefined orifice settings 110 is accurately characterized, enabling the apparatus 102 to select the most suitable orifice setting according to the given testing conditions. The determination of the calibrated flow ranges is important for establishing the operational limits of each of the one or more predefined orifice settings 110, ensuring the selected orifice can handle the expected range of the air flow during the leakage test By determining the calibrated flow range data, the apparatus 102 ensures the expected air flow data rate may be reached while maintaining precise control over the test pressure, leading to more reliable and accurate air leakage measurements.

Further, in an embodiment, the apparatus 102 is configured to determine device flow data for each of the one or more predefined orifice settings 110 based on the flow range data. The device flow data may include a minimum device flow and a maximum device flow for each of the one or more predefined orifice settings 110. The device flow data may correspond to feasible fan flow ranges [Q_{fMin}, Q_{fMax}]. of the fan of the testing device 106 for generating the required airflow through the enclosure 108 for accurately performing the leakage test. The flow range data provides the expected air flow data rates for each of the one or more predefined orifice settings which may be used to determine the device flow data.

In an exemplary embodiment, the apparatus may determine the feasible fan flow range for an orifice setting which may be represented as [Q_{fMin}, Q_{fMax}]. Accordingly, the minimum device flow (Q_{fMin}) corresponds to a minimum value of the feasible fan flow range for an orifice setting and the maximum device flow (Q_{fMax}). corresponds to the maximum value of the feasible fan flow range for the orifice setting.

Further, in an embodiment, the apparatus 102 is configured to determine target flow data for the enclosure 108 based on the device flow data and the predefined target pressure. The target flow data may correspond to a target flow range for the enclosure 108 which may be determined by the apparatus 102 by utilizing the test data, including the predefined target pressure and the device flow data to compute a flow rate of the testing device 106 necessary to achieve the predefined target pressure. Specifically, the apparatus 102 may calculate a minimum target flow rate and a maximum target flow rate [Q_{eMin}, Q_{eMax}] that correspond to the target pressure range, considering any allowable tolerance.

In an exemplary embodiment, the target enclosure flow range is determined by considering the desired pressure differential across the enclosure 108, which is set as the target pressure. For instance, if the target pressure is 25 Pascals (Pa) with tolerance of ±3 Pa, the apparatus 102 may be configured to calculate Q_{eMin} at 22 Pa and Q_{eMax} at 28 Pa.

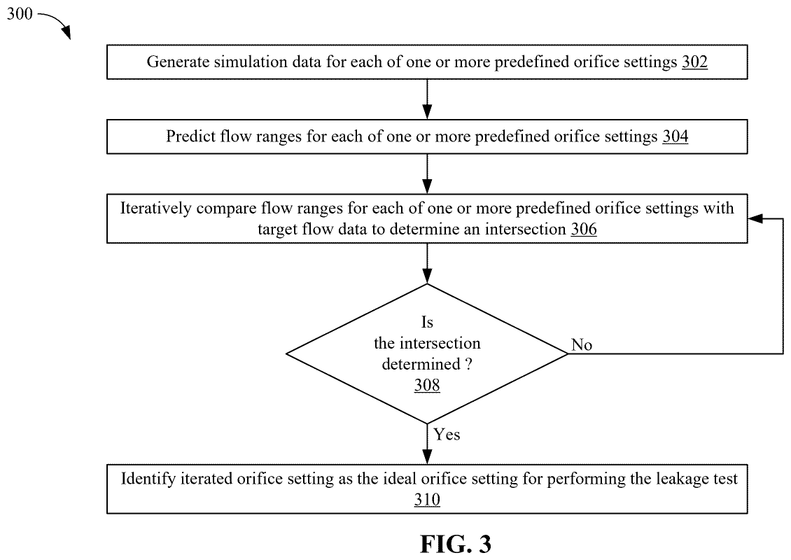

Further, in an embodiment, the apparatus 102 is configured to identify an orifice setting from the one or more predefined orifice settings 110 for performing the leakage test based on the device flow data and the target flow data. The identified orifice settings may correspond to an ideal setting of the orifice (or an orifice plate) of the testing device 106 for performing the air leakage test at the enclosure 108. The orifice setting may be identified based on the analysis of the flow range data, the device flow data, and the target flow data. The apparatus 102 may further perform simulations of each of the one or more predefined orifice settings 110 based on the analysis to identify the ideal orifice setting. The simulation process is further explained in detail in FIG. 3.

In an exemplary embodiment, the apparatus 102 may analyze features of the enclosure 108 from the retrieved one or more observation values of each of the one or more predefined orifice settings 110 to identify the setting of the orifice of the testing device 106 that may be ideal for performing the leakage test at the enclosure 108. The identified setting may be used to generate the necessary airflow for the leakage test while maintaining precise control over the test conditions. The identified setting may further ensure accurate flow and pressure measurements, resulting in reliable leakage test results.

To this end, the apparatus 102 is configured to cause, using the controller 112, to control a setting of the orifice of the testing device 106 based on the identified orifice setting for performing the leakage test. The apparatus 102 may send the identified orifice setting to the controller 112. The controller may then generate and transmit a control signal to adjust the setting of the orifice of the testing device 106. The control signal may be used to adjust the setting of the orifice to the identified orifice setting for performing the leakage test. The automated adjustment of the setting to the identified orifice setting ensures accurate leakage test results with minimal huma supervision.

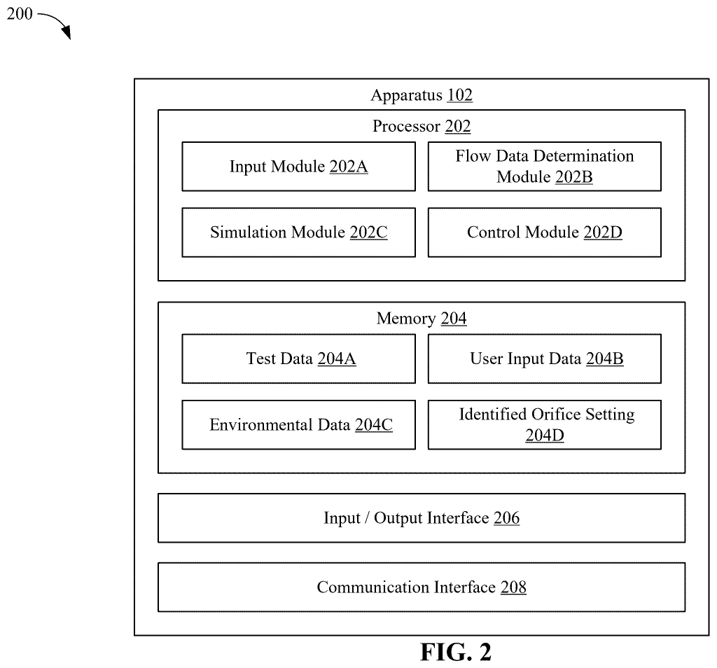

FIG. 2 illustrates a block diagram 200 of the apparatus 102 of FIG. 1, in accordance with an example embodiment of the disclosure. FIG. 2 is explained in conjunction with elements of FIG. 1.

The apparatus 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may include modules, depicted as, an input module 202A, a flow data determination module 202B, a simulation module 202C, and a control module 202D.

The processor 202 may be connected to the memory 204, and the I/O interface 206 through wired or wireless connections. Although in FIG. 2, it is shown that the apparatus 102 includes the processor 202, the memory 204, and the I/O interface 206, however, the disclosure may not be so limiting and the apparatus 102 may include fewer or more components to perform the same or other functions of the apparatus 102. In an embodiment, the input module 202A may be integrated within the I/O interface 206. In some embodiments, the input module 202A may receive data obtained by the apparatus 102. The data may include at least sensor data (from one or more sensors).

In accordance with an embodiment, the apparatus 102 may store data generated by the modules of the processor 202 in the memory 204. The data generated by the modules may include test data 204A, user input data 204B, environmental data 204C and an identified orifice setting 204D, and each of the test data 204A, the user input data 204B, the environmental data 204C and the identified orifice setting 204D, is further explained in detail.

The processor 202 of the apparatus 102 may be configured to control the orifice of a testing device 106 for performing a leakage test. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the apparatus 102. The communication interface 208 may provide an interface for accessing various features and data stored in the apparatus 102.

In some embodiments, the processor 202 may be configured to provide Internet-of-Things (IoT) related capabilities to users of the apparatus 102 disclosed herein. The IoT-related capabilities may in turn be used for performing the leakage test by providing real-time automated adjustment of the setting of the orifice to the ideal setting for performing the air leakage test. The I/O interface 206 may provide an interface for accessing various features and data stored in the apparatus 102.

The input module 202A of the processor 202 may be configured obtain test data 204A associated with the enclosure. The test data 204A may include the one or more observation values associated with the one or more predefined orifice settings 110 of the testing device 106 and the predefined target pressure for performing the leakage test. In an example, the test data 204A may be obtained from one or more sensors associated with the apparatus 102 and/or the enclosure 108. The one or more sensors may include the one or more pressure sensors for determining the pressure differential across the ends of the orifice plate.

The flow data determination module 202B of the processor 202 may be configured to calculate the flow range data for each of the one or more predefined orifice settings 110 based on the one or more observation values. In an example, the flow range data may be calculated based on the calculation of the maximum air flow through each of the one or more predefined orifice settings 110 and the calculation of the calibrated flow range data for each of the one or more predefined orifice settings 110.

In another embodiment, the flow data determination module 202B of the processor 202 may further be configured to determine the device flow data for each of the one or more predefined orifice settings 110 of the testing device 106 based on the flow range data. The device flow data includes the minimum device flow and the maximum device flow for each of the one or more predefined orifice settings. In an example, the calibrated flow range data and the maximum air flow may be used to determine the feasible fan flow range of the fan for each of the predefined orifice setting 110.

In another embodiment, the flow data determination module 202B of the processor 202 may further be configured to determine the target flow data for the enclosure 108 based on the device flow data and the predefined target pressure. In an exemplary embodiment, the flow data determination module 202B may determine the target enclosure flow range based on the predefined target pressure. The target enclosure flow range may correspond to the target flow data.

The simulation module 202C of the processor 202 may be configured to identify the orifice setting from the one or more predefined orifice settings 110 for performing the leakage test based on the device flow data and the target flow data. The simulation module 202D may simulate an orifice setting from the one or more predefined orifice settings 110 based on the target flow data, the device flow data and flow range data of the orifice setting under consideration. The simulation operation is further explained in detail in FIG. 3.

The control module 202D of the processor 202 may be configured to generate a signal for the controller 112 to control the orifice of the testing device based on the identified orifice setting 204D for performing the leakage test. In an embodiment, the apparatus 102 may be configured to cause, using the controller 112, to control the setting of the orifice of the testing device 106 based on the identified orifice setting 204D for performing the leakage test. In an example, the generated signal may cause or trigger the controller 112 to control the setting of the orifice of the testing device 106 for performing the leakage test.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

The memory 204 of the apparatus 102 may be configured to store the test data 204A. The test data 204A may include the one or more observation values and the predefined target pressure. In an embodiment, the test data 204A may include at least one of pressure differential data associated with the enclosure 108, flow vs pressure data associated with the enclosure 108, one or more enclosure parameters, orifice pressure vs flow data for each of the one or more predefined orifice settings 110, orifice characteristics of the one or more predefined orifice settings 110, or testing device characteristics. The pressure differential data may be determined by the one or more pressure sensors. The orifice plate affects flow by creating a pressure differential. In an example, the pressure differential data, in general, is a measure of pressure where the reading and reference values are variable.

The flow vs pressure data associated with the enclosure 102 may correspond to a curve representing a relationship between a flow and a pressure. The flow is an amount of fluid that moves through an open channel or closed pipe, such as the enclosure 108 and is affected by a pipe width and pressure. The pressure is an internal pressure inside the pipe, and it's affected by altitude and gravity. The relationship between flow and pressure is crucial, as an increase in pressure also increases the flow rate. This means that changes in pressure will directly change the flow rate.

The orifice pressure vs flow data may correspond to a curve representing the relationship between orifice pressure and flow. The orifice pressure refers to a pressure difference created by an orifice plate in a flow meter. The orifice plate is a thin plate with a hole in it, which is inserted into the pipeline. As the fluid, such as air flows through the orifice, the pressure upstream of the orifice gets higher than the pressure downstream. This pressure difference, also known as the differential pressure, is directly proportional to the flow rate of the fluid. The flow rate, on the other hand, refers to a volume of fluid that passes through the orifice plate per unit time.

The orifice characteristics may include information about the materials, thickness and shapes of the orifice plates of the testing device 106. The orifice plate can be made of any material, although stainless steel is the most common. The thickness, for example ranging between ⅛ inches to ½ inches, of the orifice plate may be used as a function of a line size, a process temperature, a pressure, and a differential pressure. The concentric orifice plate has a sharp (square-edged) concentric bore that provides an almost pure line contact between the plate and the fluid, with negligible friction drag at the boundary. The testing device characteristics may include information of the fan of the testing device 106. The information may include at least, but not limited to, a fan curve (f) which may be represented as a function of fan flow Fn(Q).in further calculations.

The user input data 204B may include a user input for user customized setting of the orifice of the testing device 106 for performing the leakage test. The user input data 204B may further include specific test parameters of the test parameters for performing the leakage test. In an example, the user input data 204B may be retrieved by the input module 202A of the processor 202. In one or more examples, the control module 202B may send the control signal to the controller 112 to adjust the setting of the orifice of the testing device 106 to the user customized orifice setting for performing the leakage test.

The environmental data 204C may include information about environmental factors associated with the enclosure 108. The environmental factors may include at least, but not limited to, temperature data of the enclosure 108 and humidity data of the enclosure 108. The temperature data 204C may include temperature levels of air inside the enclosure 108 and a temperature of the outside environment. The humidity data may include humidity levels of the air inside the enclosure 108. In one or more examples, the device flow range data may be adjusted based on the temperature data and the humidity data of the enclosure 108 for performing the air leakage test.

The identified orifice setting 204D may correspond to the ideal setting of the orifice of the testing device 106 for performing the leakage test. The ideal orifice setting may be used to efficiently perform the leakage test at the enclosure. In one or more examples, the identified orifice setting 204D may be selected from the one or more predefined orifice settings 110 of the testing device 106 to accurately perform the leakage test at the enclosure 108. In one or more embodiments, the controller 112 may be used to adjust the setting of the orifice of the testing device 106 to the identified orifice setting 204D.

In some example embodiments, the I/O interface 206 may communicate with the apparatus 102 and display the input and/or output of the apparatus 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or the I/O interface 206 circuitry may be configured to control one or more functions of the apparatus 102 through computer program instructions (for example, software and/or firmware) stored on the memory 204 accessible to the processor 202.

The communication interface 208 may comprise an input interface and an output interface for supporting communications to and from the apparatus 102 or any other component with which the apparatus 102 may communicate. The communication interface 208 may be any means, such as a device or circuitry embodied in either hardware or a combination of hardware and software that is configured to receive and/or transmit data to/from a communications device in communication with the apparatus 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using a machine learning model (that may be hosted on the cloud-based network).

FIG. 3 is a flowchart 300 of an exemplary method for identifying an ideal orifice setting of the testing device 106, in accordance with an embodiment of the disclosure. FIG. 3 is explained in conjunction with elements from FIG. 1 and FIG. 2. With reference to FIG. 3, there is shown the flowchart 300. The operations of the exemplary method may be executed by the apparatus 102 of FIG. 1 or the processor 202 of FIG. 2. The operations of the flowchart 300 may start at 302.

At 302, simulation data for each of the one or more predefined orifice settings 110 may be generated. In an embodiment, the apparatus 102 may be configured to generate simulation data for each of the one or more predefined orifice settings 110 based on the flow range data, the device flow data and the target flow data. The simulation data may include the feasible fan flow range of the fan of the testing device 106 for each of the one or more predefined orifice settings 110. The simulation data may further include at least one of, but not limited to, the maximum air flow and the calibrated flow range data.

In an exemplary embodiment, the simulation data may be generated by the apparatus 102 based on the retrieval of the test data 204A by the one or more differential pressure sensors. The simulation data generation operation 302 may correspond to an initiation of the identification of the optimal orifice setting operation. In one or more examples, the simulation data generation operation may be performed by the simulation module 202C of the processor 202.

At 304, flow ranges for each of the one or more predefined orifice settings 110 may be predicted. In an embodiment, the apparatus 102 may be configured to predict, using a first model, a flow range for each of the one or more predefined orifice settings 110 based on the corresponding simulation data. The flow range for each of the one or more predefined orifice settings 110 may correspond to at least one of, the feasible fan flow range, the maximum flow, or the calibrated flow range for each of the one or more predefined orifice settings 110. In an example, the flow range for an orifice setting may include the feasible fan flow range of the orifice setting, i.e., [Q_{fMin}, Q_{fMax}].

In an exemplary embodiment, the first model may correspond to at least, but not limited to, a Machine Learning model. In one or more examples, the machine learning model may be trained on vast amounts of data related to leakage tests. The machine learning model may be configured to predict the flow ranges for the orifice settings based on training data and the simulation data. In one or more examples, the machine learning model may be stored in the apparatus 102 or at any server accessible by the apparatus 102.

At 306, the flow ranges for each of the one or more predefined orifice settings 110 are iteratively compared with the target flow data to determine an intersection. In an embodiment, the apparatus 102 may be configured to iteratively compare the flow range for each of the one or more predefined orifice settings 110 with target flow data to determine an intersection. The intersection may correspond to, at least one or more common data values in the flow range for an orifice setting and the target flow data.

In an exemplary embodiment, the intersection may correspond to a common range of values between the feasible fan flow for the orifice setting [Q_{fMin}, Q_{fMax}]. and the target enclosure flow range [Q_{eMin}, Q_{eMax}]. In an alternate exemplary embodiment, the intersection may correspond to a common range of values of between the calibrated flow range for the orifice setting [Q_{0Min}, Q_{0Max}] and the target enclosure flow range [Q_{eMin}, Q_{eMax}].

At 308, the determined intersection is checked and verified. In an embodiment, the apparatus 102 may be configured to iteratively compare the flow range for each of the one or more predefined orifice settings 110 with target flow data to determine the intersection. The apparatus 102 may verify whether the intersection is determined for each of the iterated orifice settings. The verification process is based on:

$$[ {Q}_{eMin} , {Q}_{eM ax} ] ⋂ [ {Q}_{fM i n} , {Q}_{fM ax} ] \neq ∅ \qquad ( 1 )$$

this means that the target enclosure flow range [Q_{eMin}, Q_{eMax}] must overlap with the feasible fan flow range [Q_{fMin}, Q_{fMax}] for the iterated orifice setting.

At 310, the iterated orifice setting may be identified as the ideal orifice setting based on the verification of the intersection. In an embodiment, the apparatus 102 may be configured to identify the orifice setting from the one or more predefined orifice settings for performing the leakage test based on the intersection. The apparatus 102 may be configured to verify for which iterated setting the overlap or the intersection may be determined. Subsequently, the apparatus 102 may identify the iterated setting as the ideal setting for performing the leakage test at the enclosure 108.

In an exemplary embodiment, the identified orifice setting 204D may further be used for effectively performing the leakage test at the enclosure 102. The controller 112 may be configured to send a control signal to the testing device 106 automatically change the setting of the orifice plate to the identified orifice setting 204D for performing the leakage test at the enclosure 108. In one or more examples, the identified orifice setting 204D may be stored in the memory 204 of the apparatus 102.

Accordingly, blocks of the flowchart 300 support combinations of means for performing the specified functions and combinations of operations for performing the specified functions. It will also be understood that one or more blocks of the flowchart 300 can be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may include, for example, the processor 202 and/or a device or circuit for executing the computer program instructions or executing an algorithm for processing information as described above.

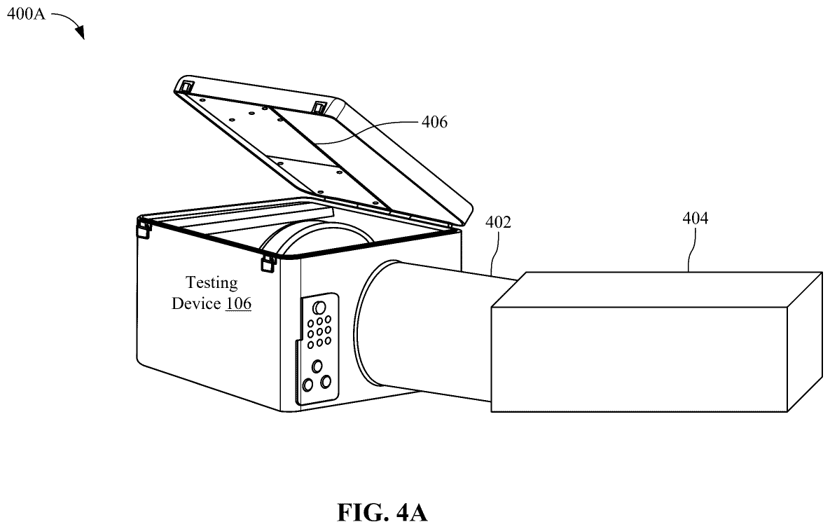

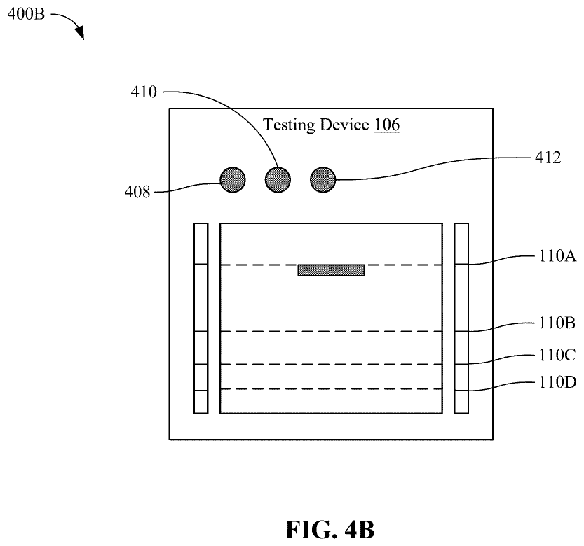

FIG. 4A illustrates an exemplary block diagram 400A of the testing device 106 for performing the leakage test, in accordance with an example embodiment of the present disclosure. With reference to FIG. 4A, there is shown a block diagram 400 A including the testing device 106 coupled to a duct 404 via a conduit 402. Further, the testing device 106 includes a control box 406. FIG. 4A is explained in conjunction with elements of FIG. 1, FIG. 2 and FIG. 3.

The testing device 106 of the present disclosure may include several key components for the purpose of leakage tests. In an example embodiment, the testing device 106 may include a flow measuring device, specifically an orifice plate flow meter, which measures the airflow through the enclosure 108 under test. The orifice plate has a smaller diameter hole compared to the main duct, creating a pressure drop that can be accurately measured. This pressure drop across the orifice plate is then used to calculate the airflow rate leaking from the duct system.

To facilitate the leakage tests, the testing device 106 may further include a flow producing unit, such as a blower or fan, that can pressurize the duct system to the desired test pressure. In an embodiment, the testing device 106 is the fan operable to supply air through the identified orifice setting 204D from the one or more predefined orifice settings 110 to the enclosure 108 for performing the leakage test. The fan allows air to be forced through the duct system and any existing leaks, which is then measured by the orifice plate flow meter. The testing device 106 may further include pressure indicating devices, such as pressure gauges or manometers, to measure the pressure drop across the orifice plate. These pressure readings, combined with the known characteristics of the orifice plate, are used to determine the airflow rate leaking from the enclosure 108.

Additionally, the testing device 106 may further include one or more accessories, for example, but not limited to, tubing, fittings, and sealing materials, to facilitate the proper integration of the orifice plate and one or more pressure ports with the enclosure 108 under test. The one or more accessories may ensure that the device can be effectively connected to the enclosure 108 for accurate leakage tests.

The conduit 402 allows passage and direction of the generated airflow from the fan to the enclosure 108. Structurally, the conduit 402 may extend from an air movement device, on the fan side, to the enclosure 108 at its inlet. At the inlet, the conduit 402 delivers the airflow. Towards the side of the testing device 106, the conduit 402 may be shaped to complement and fasten over fixtures (not shown) within the testing device 106. Towards the enclosure side, the conduit 402 may similarly extend to connect and communicate with the enclosure's inlet.

In an exemplary embodiment, connections at any of the conduit ends may include bolting, snap fitting, and other conventional fastening means. The conduit 402 may be manufactured from a waterproof and substantially flexible material to enable ease of assembly and operation. Further, high-grade plastics may be contemplated for the conduit's construction.

The duct 404 may correspond to the enclosure 108 which may be coupled to the testing device 106 via the conduit 402. In an embodiment, the duct 404 may be made from similar or dissimilar metallic materials such as galvanized steel, stainless steel, or aluminum, but is not limited thereto. It is hereby envisioned that a specific choice of materials used to make the duct 404 may be based on various factors including costs per unit length and environmental factors present at a location, for example, a site at which the installation is to be made. The duct 404 may have an opening end where the testing device 106 is connected via the conduit 402.

In an exemplary embodiment, the duct 404 may be used to distribute conditioned air (heated or cooled) throughout buildings, ensuring comfortable indoor temperatures. The duct 404 may also be used to provide ventilation in buildings, removing stale air and introducing fresh air. The duct 404 may further be used for maintaining indoor air quality and preventing mold or humidity buildup.

In another exemplary embodiment, the duct 404 may be used in commercial kitchens, ducts remove cooking smoke, grease, and odors. The duct 404 may further be used in fire safety systems to evacuate smoke during emergencies. The duct 404 may be used in material handling, dust collection, and chemical processes. The duct 404 may be used to maintain air quality and prevent harmful emissions.

The testing device 106 may further include a control box 406. The control box 406 may be configured to receive the generated signal from the controller 112 and control the one or more predefined orifice settings 110. In an embodiment, the control box 406 may adjust the setting of the orifice plate to the identified orifice settings 204D by using a device, for example, but not limited to a servo motor. In one or more example embodiments, the apparatus 102 may be configured to cause to control, using the controller 112, the servo motor of the testing device 106 to adjust the setting of the orifice of the testing device to the identified orifice setting 204D.

In an exemplary embodiment, the control box 406 may include one of, but not limited to, a programmable logic controller (PLC), a microcontroller, an electronic control unit (ECU), or an electronic control module (ECM). The control box 406 may receive an electronic control signal from the apparatus 102 and adjust the setting of the orifice of the testing device 106 for performing the leakage test.

In one or more exemplary embodiments, the testing device 106 may be connected to the duct 404 to perform the leakage tests in a series of steps. In the first step, the apparatus 102 may adjust the setting of the orifice of the testing device 106 to the identified orifice setting 204D, for example, using the servo motor. The orifice plate may then be installed in the duct 404, and the one or more pressure ports may be connected. Furhter, all supply and return openings in the duct 404 system under test may be sealed to ensure that the leakage measurements are accurate. The duct 404 system is then pressurized to the required target test pressure using the flow producing unit. The pressure drop across the orifice plate may then be measured, and this data may be used to calculate the airflow rate leaking from the duct 404. Finally, the measured leakage rate is compared to the allowable leakage limits to determine whether the duct 404 passes or fails the test.

A key advantage of using the testing device 106 connected with the apparatus 102 is the ability of the apparatus 102 to automatically adjust the setting of the orifice to the ideal setting for performing the leakage test. The problem associated with the conventional methods of leakage tests is also solved. The testing device 106 also enables a feature to accurately measure a wide range of airflow rates by automatically adjusting the orifice configurations. This versatility makes the device a valuable tool for duct 404 leakage testing in various applications.

FIG. 4B illustrates a cross-sectional view 400B of the testing device 106 of FIG. 1 for performing the leakage test, in accordance with an example embodiment of the present disclosure. For example, the testing device 106 is a fan. The testing device 106 further includes a reference pressure port 408, a duct pressure port 410 and a fan pressure port 412. Further, the testing device 106 may include a first predefined orifice setting 110A, a second predefined orifice setting 110B, a third predefined orifice setting 110C, and a fourth predefined orifice setting 110D. FIG. 4B is explained in conjunction with elements of FIG. 1 and FIG. 4A.

The testing device 106 may include the reference pressure port 408. The reference pressure port 408 may be input a reference pressure to the testing device 106 from a reference pressure sensor. The reference pressure sensor may be configured to measure the atmospheric pressure and serves as a baseline against which other pressure readings are compared. The reference pressure may be determined by the testing device 106 through the reference pressure port 408.

Further, the testing device 106 may include the duct pressure port 410. The duct pressure port 410 may be input a duct pressure to the testing device 106 from a duct pressure sensor. The duct pressure sensor may be configured to measure air pressure in the enclosure 108, for example, when the duct is conducting conditioned air and/or when fan air is flowing through the enclosure 108 for air leakage testing. The duct pressure sensor 410 is connected via an external pipe to measure the pressure inside the enclosure 108 relative to atmospheric pressure or the reference pressure. In an example, the duct pressure is higher than the reference pressure. The duct pressure may be determined by the testing device 106 through the duct pressure port 410.

Further, the testing device 106 may include a fan pressure port 412. The fan pressure port 412 may be input a fan pressure to the testing device 106 from a fan pressure sensor. The fan pressure sensor is configured to measure a pressure generated from the fan, which is important for understanding the performance of the fan in generating airflow. In an embodiment, the pressure generated from the fan is negative, indicating a pressure drop as air moves through the fan before being directed into the enclosure 108. This negative fan pressure is important for creating the necessary pressure differentials used to assess the air leakage. The fan pressure may be determined by the testing device 106 through the fan pressure port 412.

The reference pressure sensor, the duct pressure sensor and the fan pressure sensor (collectively referred to as pressure sensors) may be one of the commonly known pressure sensing devices in the art, such as a monometer, and may be configured to monitor a pressure difference created by an airflow directed out from the fan, and into the enclosure 108. The duct pressure sensor may sense pressure within the enclosure 108 and the fan pressure sensor may sense pressure around the fan to generate a corresponding signal, and provides that signal through analog or digital means.

In one or more exemplary embodiments, visual, audible, or a combination of both, may constitute feedback to an operator. It is evident to the person with ordinary skills in the art that a type of the pressure sensors to be a manometer is only exemplary and should not be construed as a limitation, and the type of the pressure sensors may incorporate other known technologies in the art.

The testing device 106 is equipped with the one or more predefined orifice settings 110. Each of the one or more predefined orifice settings 110 allow air from the outside to be blown into the enclosure 108. Each of the one or more predefined orifice settings 110 is designed to handle specific flow rate and the pressure conditions. In an example, the testing device 106 may comprise definite number of orifices setting such as, but not limited to four-orifice settings.

The first predefined orifice setting 110A allows maximum airflow to the enclosure 108. The second predefined orifice setting 110B allows an airflow lesser than the maximum airflow of the first predefined orifice setting 110A. The third predefined orifice setting 110C allows airflow to the enclosure 108 that is lesser than the airflow allowed by the second predefined orifice setting 110B. The fourth predefined orifice setting 110D allows minimum airflow to the enclosure 108 that is lesser than the airflow allowed by the third predefined orifice setting 110C. The orifice setting may be designed to match the leakage conditions.

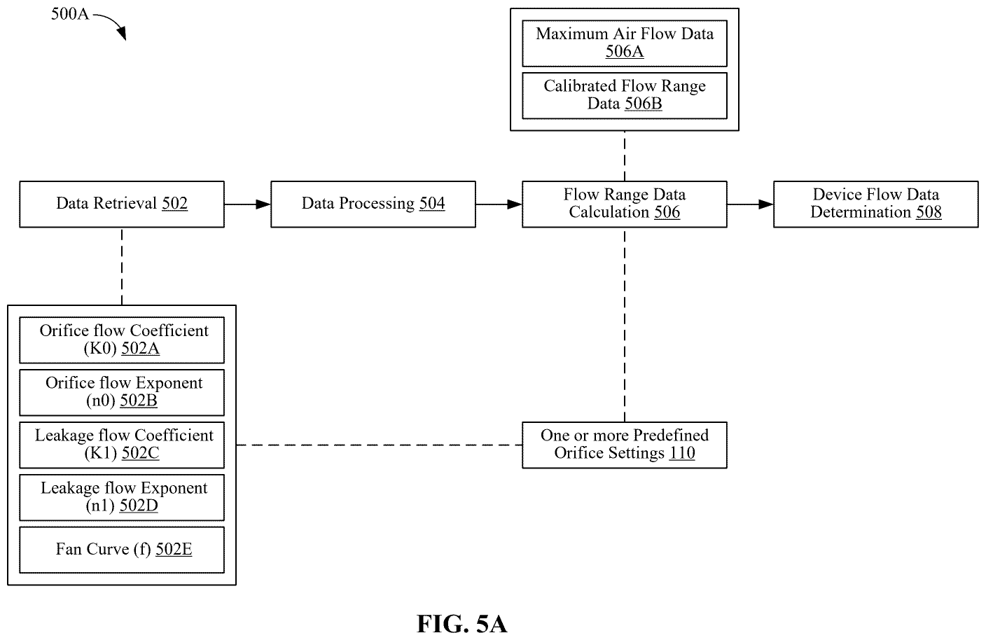

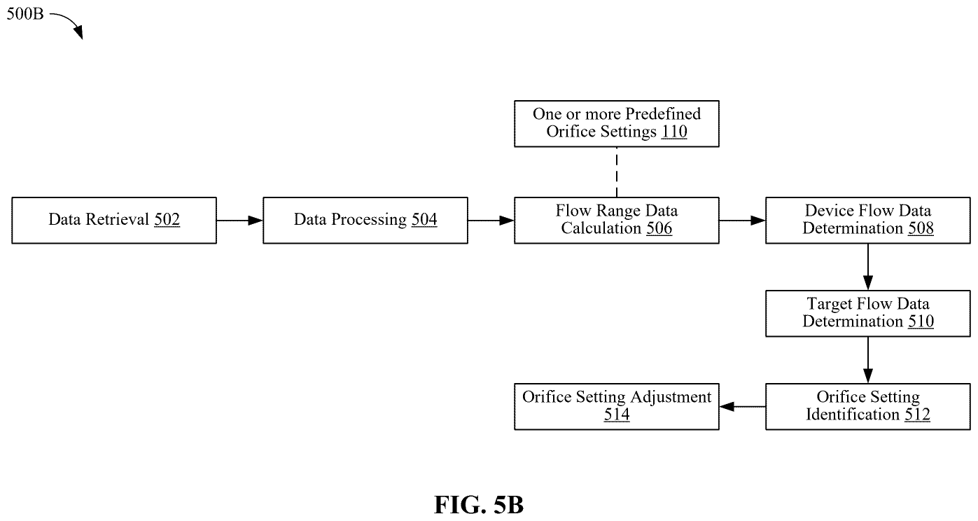

FIG. 5A is a diagram 500A that illustrates exemplary operations for determining device flow data for each of one or more predefined orifice settings 110 of the testing device 106, in accordance with an example embodiment of the present disclosure. With reference to FIG. 5A, there is shown the block diagram 500A that illustrates exemplary operations from 502 to 508, as described herein. The exemplary operations illustrated in the block diagram 500A may start at 502 and may be performed by the apparatus 102 of FIG. 1 or the processor 202 of FIG. 2. Although illustrated with discrete blocks, the exemplary operations associated with one or more blocks of the block diagram 500A may be divided into additional blocks, combined into fewer blocks, or eliminated, depending on the particular implementation. FIG. 5A is explained in conjunction with FIG. 1-FIG. 4B.

At 502, a data retrieval operation may be performed. In an embodiment, the apparatus 102 may obtain test data 204A associated with the enclosure 108. The test data 204A may include the one or more observation values associated with the one or more predefined orifice settings 110 of the testing device 106, and the predefined target pressure for performing the leakage test. In an example, the input module 202A of the processor 202 may be configured to obtain the test data 204A.

In an embodiment, the one or more observation values of the test data 204A may include at least an orifice flow coefficient (k₀) 502A, an orifice flow exponent (n₀) 502B, a leakage flow coefficient (k₁) 502C, a leakage flow exponent (n₁) 502D, and a fan curve (f) 502E. The orifice flow coefficient (k₀) 502A may refer to the characteristics flow capability of each of the one or more predefined orifice settings 110. The orifice flow exponent (n₀) 502B may refer to the relationship between the pressure and flow for each of the one or more predefined orifice settings 110. The leakage flow coefficient (K₁) 502C may refer to the coefficient that quantifies the leakage characteristics of the enclosure (such as enclosure 108). The leakage flow exponent (n₁) 502D may indicate how leakage flow varies with pressure. The fan curve (f) 502E may refer to performance characteristics of the fan used in the testing device 106. The fan curve (f) is represented as a function of fan flow Fₙ (Q) for further calculations.

At 504, the retrieved data may be processed. In an embodiment, the apparatus 102 may be configured to calculate the flow range data for each of the one or more predefined orifice settings 110 based on the one or more observation values. In an example, the orifice flow coefficient (k₀) 502A, the orifice flow exponent (n₀) 502B may be used to determine the flow range data. In one or more examples, the fan curve (f) 502E may be used to determine the flow range data.

At 506, a flow range data calculation operation may be performed. In an embodiment, the apparatus 102 may be configured to calculate the flow range data for each of the one or more predefined orifice settings 110 based on the one or more observation values. In an additional embodiment, the flow range data further includes at least one of a maximum air flow data 506A associated with each of the one or more predefined orifice settings 110, or calibrated flow range data 506B for each of the one or more predefined orifice settings 110. The maximum flow range data 506A may correspond to the maximum air flow Qₘₐₓ through each of the one or more predefined orifice settings 110. The calibrated flow range data 506B correspond to a calibrated flow range [Q_{0Min}, Q_{0Max}] for each of the one or more predefined orifice settings 110.

In one or more embodiments, the apparatus 102 may be configured to determine the maximum air flow, Qₘₐₓ, through each of the one or more predefined orifice settings 110 using the obtained test data 204A, such as the orifice flow coefficient 502A and the orifice flow exponent 502B. In an example, the maximum air flow, Qₘₐₓ, is the maximum air flow that fan could put in at a given orifice setting. The one or more air flows through each of the one more predefined orifice settings 110 is determined based on:

$$Q = {KP}^{n} \qquad ( 2 )$$

where Q is air flow and P is the pressure using the orifice flow coefficient 502A and the orifice flow exponent 502B, of each of the one or more predefined orifice settings 110.

The maximum air flow, Qₘₐₓ, is determined for each of the one or more predefined orifice settings 110 though root finding algorithms including, but not limited to, Newton Raphson root finding algorithm. The Qₘₐₓ is determined based on:

$$f ( {Q}_{M ax} ) = {P}_{M ax} = {( \frac{{Q}_{M ax}}{{K}_{0}} )}^{\frac{1}{{n}_{0}}} + {( \frac{{Q}_{Ma x}}{K 1} )}^{\frac{1}{{n}_{1}}} \qquad ( 3 )$$

Further, Eq. (3) may be solved for a value of Qₘₐₓ as:

$$0 = {( \frac{{Q}_{M ax}}{{K}_{0}} )}^{\frac{1}{{n}_{0}}} + {( \frac{{Q}_{M ax}}{K 1} )}^{\frac{1}{{n}_{1}}} - f ( {Q}_{M ax} )$$

In an example, the value of the n₀, n₁ is set as 0.5 due to which the equation (2) become quadratic equation and by solving for a root of the Eq. (2), a value for Qₘₐₓ is determined.

In additional embodiment, the apparatus 102 may be configured to determine the calibrated flow ranges [Q_{0Min}, Q_{0Max}] for each of the one or more predefined orifice settings 110 using the obtained test data 204A, such as the orifice flow coefficient 502A and the orifice flow exponent 502B, and the maximum air flow. In an example, solving the roots of the Eq (2) may provide us with the values of the calibrated flow range [Q_{0Min}, Q_{0Max}] for a given orifice. One of the roots of the equation is the maximum air flow Q_{0Max} for the calibration of the given orifice and the other root is the minimum air flow Q_{0Min} for the calibration of the given orifice.

At 508, a device flow data determination operation may be performed. In an embodiment, the apparatus 102 may be configured to determine the device flow data for each of the one or more predefined orifice settings 110 of the testing device 106 based on the flow range data. The device flow data may include the minimum device flow and the maximum device flow for each of the one or more predefined orifice settings In an example, the device flow data may be determined based on the flow range data calculation operation 506.

In one or more embodiments, the apparatus 102 may be configured to determine feasible fan flow ranges of the fan of the testing device 106 for each of the one or more predefined orifice settings 110 based on an intersection of the calibrated flow range data with the fan's flow capabilities. Specifically, a feasible fan flow range for a given orifice setting is determined based on:

$$[ {Q}_{0 Mi n} , {Q}_{0 M ax} ] ⋂ [ 0 , {Q}_{m ax} ] = [ {Q}_{fM i n} , {Q}_{fMa x} ] \qquad ( 4 )$$

Where [Q_{0Min}, Q_{0Max}] represents the given orifice's setting calibrated flow range and [0, Q_{Max}] denotes the fan's maximum operational flow range.

The intersection of these ranges [Q_{fMin}, Q_{fMax}], identifies the feasible fan flow range for the given orifice setting of the testing device 106 that can be achieved with the given orifice setting under the specified condition. This ensures that the selected orifice setting of the testing device 106 can accommodate the required airflow rates, providing accurate and reliable air leakage measurement for the testing process.

FIG. 5B is a diagram 500B that illustrates exemplary operations for controlling the orifice of the testing device 106, in accordance with an example embodiment of the present disclosure. With reference to FIG. 5B, there is shown the block diagram 500B that illustrates exemplary operations from 502 to 514, as described herein. The exemplary operations illustrated in the block diagram 500B may start at 502 and may be performed by the apparatus 102 of FIG. 1 or the processor 202 of FIG. 2. Although illustrated with discrete blocks, the exemplary operations associated with one or more blocks of the block diagram 500B may be divided into additional blocks, combined into fewer blocks, or eliminated, depending on the particular implementation. FIG. 5B is explained in conjunction with FIG. 1-FIG. 5A. Details about the operations 502-508 of FIG. 5B are explained in detail in FIG. 5A.

At 510, a target flow data calculation operation may be performed. In an embodiment, the apparatus 102 may be configured to determine the target flow data for the enclosure 108 based on the device flow data and the predefined target pressure. The target flow data may include the target enclosure flow range for the enclosure 108. In an example, the apparatus 102 is configured to determine the target enclosure flow range to reach the test target pressure, and calculated based on the flow equation. The target flow range may be represented as [Q_{eMin}, Q_{eMax}].

In an example, if the target pressure is set as 25 Pa, the apparatus 102 ensures that the duct pressure stays within the tolerance range. For example, the tolerance of ±2. To keep the target enclosure flow in specified pressure range, the apparatus 102 is configured to calculate Q_{eMin} as the flow rate corresponding to the target pressure minus 2 Pa (i.e., 22 Pa) and the Q_{eMax} as the flow rate corresponding to the target pressure plus 2 Pa (i.e., 28 Pa). This ensures that the air flow in the test environment or the duct 106 remains within the desired pressure range during testing.

At 512, an orifice setting identification operation may be performed. In an embodiment, the apparatus 102 may be configured to identify the orifice setting from the one or more predefined orifice settings 110 for performing the leakage test based on the device flow data and the target flow data. The apparatus 102 is configured to analyze the device flow data and the target flow data and run simulations for each of the one or more predefined orifice settings 110 to identify the orifice settings. The simulation is performed by the apparatus 102 by checking if the target enclosure flow range intersects with the feasible fan flow range for the given orifice setting. The verification process is based on:

$$[ {Q}_{eM i n} , {Q}_{e Ma x} ] ⋂ [ {Q}_{fMin} , {Q}_{fM ax} ] \neq ∅ \qquad ( 5 )$$

this means that the target enclosure flow range [Q_{eMin}, Q_{eMax}] must overlap with the feasible fan flow range [Q_{fMin}, Q_{faMx}] for the given orifice setting.

If there is an intersection, it confirms that the given orifice setting may achieve the required flow rates within the specified pressure range and may be identified as the ideal orifice setting for performing the leakage test. If no intersection exists, the given orifice setting is deemed invalid, indicating that it cannot provide the necessary flow for accurate testing and another orifice setting from the one or more predefined orifice settings 110 may be checked for verification. The simulation process is explained in detail in FIG. 3.

At 514, the orifice setting of the testing device 106 may be adjusted. In an embodiment, the apparatus 102 may be configured to cause, using the controller 112, to control the setting of the orifice of the testing device 106 based on the identified orifice setting 204D for performing the leakage test. The apparatus 102 may send a control signal to the controller 112 to adjust the setting of the orifice of the testing device 106 to the identified orifice setting 204D.

In an exemplary embodiment, the control box 406 may receive the control signal from the apparatus 102 and cause the servo motor to adjust the setting of the orifice of the testing device 106 for performing the leakage test. The setting may be adjusted to the identified orifice setting 204D by the apparatus 102. The identified orifice setting 204D may be for example, the second predefined orifice setting 110B.

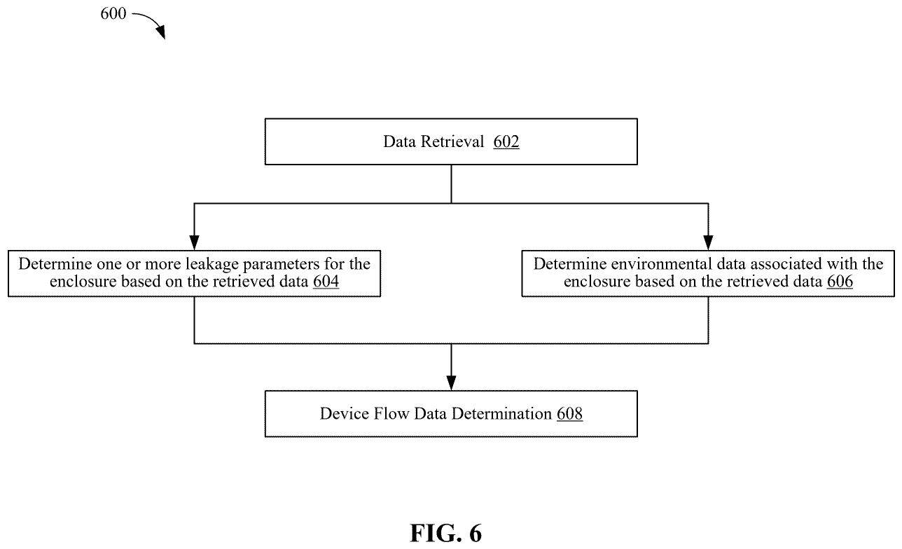

FIG. 6 is a diagram that illustrates an exemplary method for determining device flow data for each of one or more predefined orifice settings of the testing device of FIG. 1, in accordance with an example embodiment of the present disclosure. FIG. 6 is explained in conjunction with elements from FIG. 1-FIG. 5B. The operations of the exemplary method may be executed by the apparatus 102 of FIG. 1 or the processor 202 of FIG. 2. The operations of the flowchart 600 may start at 602.

At 602, the data retrieval operation may be performed. The data retrieval is explained in conjunction with FIG. 5A. The retrieved data, i.e., test data, may include the one or more observation values of the obtained test data 204A including, for example, the orifice flow coefficient (k₀) 502A, the orifice flow exponent (n₀) 502B, the leakage flow coefficient (k₁) 502C, the leakage flow exponent (n₁) 502D, and the fan curve (f) 502E. In an example, the apparatus 102 may be configured to obtain the leakage flow coefficient (k₁) 502C and the leakage flow exponent (n₁) 502D associated with the enclosure 102.

In one or more embodiments, the apparatus 102 may be configured to obtain the environmental data 204C associated with the enclosure 108. In this context, the apparatus 102 may be configured to obtain the temperature data of the enclosure 108 or the humidity data of the enclosure 108. In one or more examples, the temperature data may include temperature levels of air inside the enclosure 108 and a temperature of the outside environment. The humidity data may include humidity levels of the air inside the enclosure 108.

At 604, one or more leakage parameters associated with the enclosure may be determined. The one or more leakage parameters may be determined based on the retrieved data. In an embodiment, the apparatus 102 may be configured to determine the one or more leakage parameters associated with the enclosure 108 based on the test data 204A.

In an example embodiment, the apparatus 102 may obtain sensor data from the one or more pressure sensors and the one or more flow sensors arranged in the enclosure 108. The apparatus 102 may then determine the leakage flow coefficient (k₁) 502C and the leakage flow exponent (n₁) 502D associated with the enclosure 108 based on the sensor data.

At 606, the environmental data associated with the enclosure may be determined. In an embodiment, the apparatus 102 may be configured to obtain the environmental data 204C associated with the enclosure. The environmental data 204C may include the temperature data associated with the enclosure 108 and the humidity data associated with the enclosure 108. In an example embodiment, one or more temperature sensors and humidity sensors may also be arranged in connection with the enclosure 108 to measure the temperature data and the humidity data associated with the enclosure 108.

At 608, the device flow data may be determined. In an embodiment, the apparatus 102 may be configured to determine the device flow data for each of the one or more predefined orifice settings 110 of the testing device 106 based on the one or more leakage parameters. The apparatus 102 may be configured to identify the leakage conditions at the enclosure 108 based on the leakage flow coefficient (k₁) 502C and the leakage flow exponent (n₁) 502D.

In this context, the apparatus 102 may determine the maximum feasible fan flow which can be provided by the fan of the testing device 106 based on the leakage conditions to perform the leakage tests efficiently by the testing device 106. The apparatus 102 may then determine the device flow data for each of the of the one or more predefined orifice settings 110 of the testing device 106.

In one or more embodiments, the apparatus 102 may be configured to determine the device flow data for each of the one or more predefined orifice settings 110 based on the environmental data 204C. The apparatus 102 may adjust the device flow data based on the environmental data 204C. In an example, the feasible fan flow may be increased based on when the temperature at the enclosure 108 may be greater than a threshold value.

Accordingly, blocks of the flowchart 600 support combinations of means for performing the specified functions and combinations of operations for performing the specified functions. It will also be understood that one or more blocks of the flowchart 600 can be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may include, for example, the processor 202 and/or a device or circuit for executing the computer program instructions or executing an algorithm for processing information as described above.

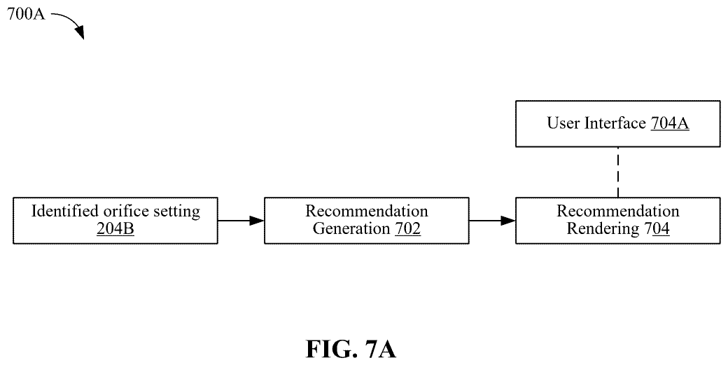

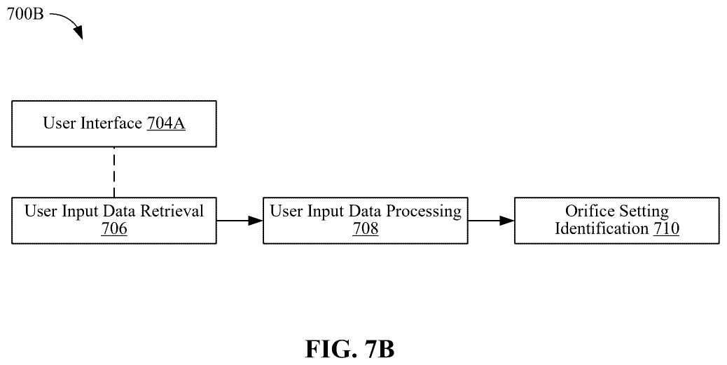

FIG. 7A is a diagram 700A that illustrates exemplary operations for recommending the orifice setting of the testing device of FIG. 1, in accordance with an example embodiment of the present disclosure. With reference to FIG. 7A, there is shown the block diagram 700A that illustrates exemplary operations from 702 to 704, as described herein. The exemplary operations illustrated in the block diagram 700A may start at 702 and may be performed by the apparatus 102 of FIG. 1 or the processor 202 of FIG. 2. Although illustrated with discrete blocks, the exemplary operations associated with one or more blocks of the block diagram 700A may be divided into additional blocks, combined into fewer blocks, or eliminated, depending on the particular implementation. FIG. 7A is explained in conjunction with FIG. 1-FIG. 6.

At 702, a recommendation generation operation may be performed. In an embodiment, the apparatus 102 may be configured to generate a recommendation of ideal orifice setting for the leakage test based on the identified orifice setting 204D. The apparatus 102 may recommend the identified orifice setting 204D to a user of the testing device 106 for performing the leakage test. The user may use the recommendation to manually adjust the setting of the orifice of the testing device 106 to the identified orifice setting 204D for performing the leakage test.

In an example embodiment, when a user may want to use the testing device 106 to manually set the setting of the orifice, the apparatus 102 may generate the recommendation for the user to appropriately select the ideal setting for performing the leakage test. The generated recommendation may be further used for selecting the ideal setting by the user for performing air leakage test. In one or more examples, in case of a failure of the servo motor of the testing device 106, the generated recommendation may be used to manually set the orifice setting.

At 704, a recommendation rendering operation may be performed. In an embodiment, the apparatus 102 may be configured to display, via a user interface 704A, the generated recommendation. The user interface 704A may be provided by the input/output module 206 of the apparatus 102. The user interface 704A may be used to render the recommendation of the identified orifice setting 204D generated by the apparatus 102. In an example, the user interface 704A may output the generated recommendation for performing the leakage test efficiently at the enclosure 108.

FIG. 7B is a diagram 700B that illustrates exemplary operations for orifice setting identification of the testing device of FIG. 1 for performing the leakage test, in accordance with an example embodiment of the present disclosure. With reference to FIG. 7B, there is shown the block diagram 700B that illustrates exemplary operations from 706 to 708, as described herein. The exemplary operations illustrated in the block diagram 700B may start at 706 and may be performed by the apparatus 102 of FIG. 1 or the processor 202 of FIG. 2. Although illustrated with discrete blocks, the exemplary operations associated with one or more blocks of the block diagram 700A may be divided into additional blocks, combined into fewer blocks, or eliminated, depending on the particular implementation. FIG. 7B is explained in conjunction with FIG. 1-FIG. 6.

At 706, a user input data retrieval operation may be performed. In an embodiment, the apparatus 102 may be configured to receive a user input via a user interface 704A. The user input may be associated with performing the leakage test. The user input may include customized setting of the orifice of the testing device 106. The user input may include the specific test parameters for performing the leakage test at the enclosure 108. The apparatus 102 may obtain the user input and store it in the memory in the form of user input data 204B for further operations.

In an example embodiment, the user may want to use customized orifice settings suggested by some technician for performing the leakage test. In this context, the apparatus 102 may identify the ideal setting as the customized orifice setting which may be provided by the user through the user interface 704A as the user input data 204B. In one or more examples, the user may want to input some specific test parameters associated with the enclosure 108 for performing the leakage test. In this context, the user may input the specific test parameters via the user interface 704A.

At 708, the user input data processing operation may be performed. In an embodiment, the apparatus 102 may be configured to identify the orifice setting from the one or more predefined orifice settings 110 for performing the leakage test based on the user input. The apparatus 102 may use the obtained user input to identify the ideal orifice setting for performing the leakage test at the enclosure 108. In an example, the apparatus 102 may identify the setting based on the user input data 204B from the memory 204.

At 710, the orifice setting identification operation may be performed. In an embodiment, the apparatus 102 may be configured to identify the orifice setting from the one or more predefined orifice settings 110 for performing the leakage test based on the user input. The apparatus 102 may identify the customized orifice setting as the ideal orifice setting and adjust the setting of the orifice of the testing device 106 based on the customized orifice setting.

In an exemplary embodiment, the user may want to set a technician suggested customized orifice setting. In this context, the apparatus 102 may send a control signal to the controller 112 based on the retrieval of the user input data. The controller 112 may further adjust the setting of the orifice of the testing device 106 to the received customized orifice setting for performing the leakage test.

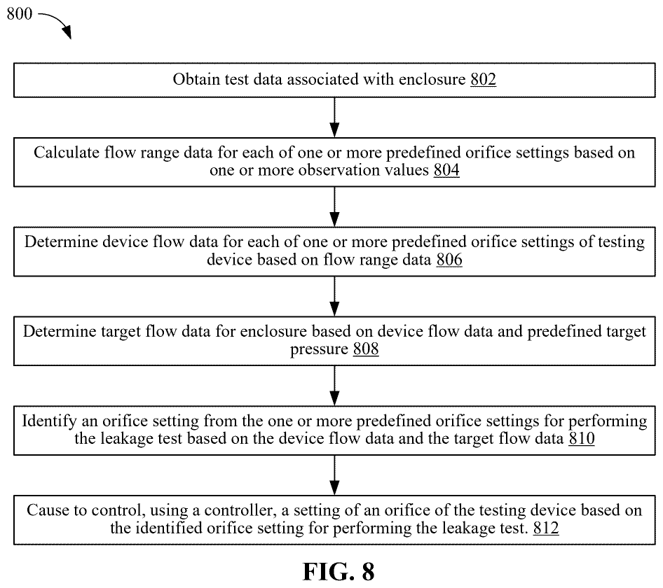

FIG. 8 is a flowchart 800 that illustrates an exemplary method for controlling an orifice of a testing device for performing a leakage test, in accordance with an embodiment of the disclosure. FIG. 8 is explained in conjunction with elements from FIG. 1-FIG. 7B. With reference to FIG. 8, there is shown the flowchart 800. The operations of the exemplary method may be executed by the apparatus 102 of FIG. 1 or the processor 202 of FIG. 2. The operations of the flowchart 800 may start at 802.

At 802, test data associated with an enclosure may be obtained. In an embodiment, the apparatus 102 may be configured to obtain the test data 204A associated with the enclosure 108. The test data 204A may further include the one or more observation values associated with the one or more predefined orifice settings 110 and the predefined target pressure. In one or more examples, the test data 204A may be obtained by the input module 202A of the processor 202.

In an exemplary embodiment, the apparatus 102 may retrieve the test data 204A from one or more sensors associated with the testing device 106. The one or more sensors may include at least, but not limited to, pressure sensors, flow sensors, temperature sensors, and humidity sensors. In one or more examples, the test data 204 retrieval may correspond to an initiation of a control operation of the setting of the orifice.

At 804, flow range data for each of one or more predefined orifice settings may be calculated. In an embodiment, the apparatus 102 may be configured to calculate the flow range data for each of the one or more predefined orifice settings 110 based on the one or more observation values. The flow range data may include the maximum air flow data 506A and the calibrated flow range data 506B for each of the one or more predefined orifice settings 110. In one or more examples, the flow range data may be calculated by the flow data determination module 202B of the processor 202.

At 806, device flow data for each of one or more predefined orifice settings may be determined. In an embodiment, the apparatus 102 may be configured to determine the device flow data for each of the one or more predefined orifice settings 110 of the testing device 106 based on the flow range data. The device flow data may further include the minimum device flow and the maximum device flow for each of the one or more predefined orifice settings 110. In one or more examples, the device flow data may be determined by the flow data determination module 202B of the processor 202.

At 808, target flow data for the enclosure may be determined. In an embodiment, the apparatus 102 may be configured to determine the target flow data for the enclosure 108 based on the device flow data and the predefined target pressure. The target flow data may include the target enclosure flow range associated with the enclosure 108. In an example, the target flow data may be determined by the flow data determination module 202B of the processor 202.

At 810, an orifice setting may be identified from the one or more predefined orifice settings. In an embodiment, the apparatus 102 may be configured to identify the setting of the orifice from one or more predefined orifice settings 110 for performing the leakage test based on the device flow data and the target flow data. The apparatus 102 may analyze the device flow data and the target flow data and simulate each of the one or more predefined orifice settings 110 to identify the ideal orifice setting. In an example, the orifice setting may be identified by the simulation module 202C of the processor 202.

At 812, a setting of an orifice of the testing device may be caused to be controlled by a controller based on the identified orifice setting for performing the leakage test. In an embodiment, the apparatus 102 may be configured to cause to control, using the controller 112, the setting of the orifice of the testing device based on the identified orifice setting for performing the leakage test. The apparatus 102 may adjust the setting of the orifice of the testing device 106 to the identified orifice setting for accurately performing the leakage test at the enclosure 108. In one or more examples, the orifice setting may be adjusted by the control module 202D of the processor 202.

Accordingly, blocks of the flowchart 800 support combinations of means for performing the specified functions and combinations of operations for performing the specified functions. It will also be understood the one or more blocks of the flowchart 800 and can be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may include, for example, the processor 202 and/or a device or circuit for executing the computer program instructions or executing an algorithm for processing information as described above.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for controlling an orifice of a testing device for performing a leakage test, the apparatus comprising:
a memory configured to store computer executable instructions; and
one or more processors configured to execute the instructions to:
obtain test data associated with an enclosure, wherein the test data comprises one or more observation values associated with one or more predefined orifice settings of the testing device, and a predefined target pressure for performing the leakage test;
calculate flow range data for each of the one or more predefined orifice settings based on the one or more observation values;
determine device flow data for each of the one or more predefined orifice settings of the testing device based on the flow range data, wherein the device flow data comprises a minimum device flow and a maximum device flow for each of the one or more predefined orifice settings;
determine target flow data for the enclosure based on the device flow data and the predefined target pressure;
identify an orifice setting from the one or more predefined orifice settings for performing the leakage test based on the device flow data and the target flow data; and
cause to control, using a controller, a setting of the orifice of the testing device based on the identified orifice setting for performing the leakage test.

2. The apparatus of claim 1, wherein the one or more processors are further configured to execute the instructions to:
generate simulation data for each of the one or more predefined orifice settings based on the flow range data, the device flow data and the target flow data;
predict, using a first model, a flow range for each of the one or more predefined orifice settings based on the corresponding simulation data;
iteratively compare the flow range for each of the one or more predefined orifice settings with target flow data to determine an intersection; and
identify the orifice setting from the one or more predefined orifice settings for performing the leakage test based on the intersection.

3. The apparatus of claim 1, wherein the one or more processors are further configured to execute the instructions to:
determine one or more leakage parameters associated with the enclosure based on the test data; and
determine the device flow data for each of the one or more predefined orifice settings of the testing device based on the one or more leakage parameters.

4. The apparatus of claim 1, wherein the testing device is a fan operable to supply air through the identified orifice setting from the one or more predefined orifice settings to the enclosure for performing the leakage test.

5. The apparatus of claim 1, wherein the test data comprises at least one of: pressure differential data associated with the enclosure, flow vs pressure data associated with the enclosure, one or more enclosure parameters, orifice pressure vs flow data for each of the one or more predefined orifice settings, orifice characteristics of the one or more predefined orifice settings, or testing device characteristics.

6. The apparatus of claim 1, wherein the flow range data comprises at least one of: maximum air flow data associated with each of the one or more predefined orifice settings, or calibrated flow range data for each of the one or more predefined orifice settings.

7. The apparatus of claim 1, wherein the one or more processors are further configured to execute the instructions to generate a recommendation for the leakage test based on the identified orifice setting.

8. The apparatus of claim 7, wherein the one or more processors are further configured to execute the instructions to display, via a user interface, the generated recommendation.

9. The apparatus of claim 8, wherein the one or more processors are further configured to execute the instructions to:
receive a user input via the user interface, wherein the user input is associated with performing the leakage test; and
identify the orifice setting from the one or more predefined orifice settings for performing the leakage test based on the user input.

10. The apparatus of claim 1, wherein the one or more processors are further configured to execute the instructions to:
obtain environmental data associated with the enclosure; and
determine the device flow data for each of the one or more predefined orifice settings based on the environmental data.

11. The apparatus of claim 1, wherein the one or more observation values comprises at least one of: an orifice flow coefficient (k₀), an orifice flow exponent (n₀), a leakage flow coefficient (k₁), a leakage flow exponent (n₁), and a fan curve (f).

12. A method for controlling an orifice of a testing device for performing a leakage test, the method comprising:
obtaining test data associated with an enclosure, wherein the test data comprises one or more observation values associated with one or more predefined orifice settings of the testing device, and a predefined target pressure for performing the leakage test;
calculating flow range data for each of the one or more predefined orifice settings based on the one or more observation values;
determining device flow data for each of the one or more predefined orifice settings of the testing device based on the flow range data, wherein the device flow data comprises a minimum device flow and a maximum device flow for each of the one or more predefined orifice settings;
determining target flow data for the enclosure based on the device flow data and the predefined target pressure;
identifying an orifice setting from the one or more predefined orifice settings for performing the leakage test based on the device flow data and the target flow data; and
causing to control, using a controller, a setting of the orifice of the testing device based on the identified orifice setting for performing the leakage test.

13. The method of claim 12 further comprising:
generating simulation data for each of the one or more predefined orifice settings based on the flow range data, the device flow data and the target flow data;
predicting, using a first model, a flow range for each of the one or more predefined orifice settings based on the corresponding simulation data;
iteratively comparing the flow range for each of the one or more predefined orifice settings with target flow data to determine an intersection; and
identifying the orifice setting from the one or more predefined orifice settings for performing the leakage test based on the intersection.

14. The method of claim 12 further comprising:
determining one or more leakage parameters associated with the enclosure based on the test data; and
determining the device flow data for each of the one or more predefined orifice settings of the testing device based on the one or more leakage parameters.

15. The method of claim 12, wherein the testing device is a fan operable to supply air through the identified orifice setting from the one or more predefined orifice settings to the enclosure for performing the leakage test.

16. The method of claim 12, wherein the test data comprises at least one of: pressure differential data associated with the enclosure, flow vs pressure data associated with the enclosure, one or more enclosure parameters, orifice pressure vs flow data for each of the one or more predefined orifice settings, orifice characteristics of the one or more predefined orifice settings, or testing device characteristics.

17. The method of claim 12, wherein the flow range data comprises at least one of: maximum air flow data associated with each of the one or more predefined orifice settings, or calibrated flow range data for each of the one or more predefined orifice settings.

18. The method of claim 12 further comprising generating a recommendation for the leakage test based on the identified orifice setting.

19. The method of claim 12, the one or more observation values comprises at least one of: an orifice flow coefficient (k₀), an orifice flow exponent (n₀), a leakage flow coefficient (k₁), a leakage flow exponent (n₁), and a fan curve (f).

20. A computer programmable product for controlling an orifice of a testing device for performing a leakage test, the computer programmable product comprising a non-transitory computer readable medium having stored thereon computer executable instructions, which when executed by one or more processors, cause the one or more processors to carry out operations comprising:
obtaining test data associated with an enclosure, wherein the test data comprises one or more observation values associated with one or more predefined orifice settings of the testing device, and a predefined target pressure for performing the leakage test;
calculating flow range data for each of the one or more predefined orifice settings based on the one or more observation values;
determining device flow data for each of the one or more predefined orifice settings of the testing device based on the flow range data, wherein the device flow data comprises a minimum device flow and a maximum device flow for each of the one or more predefined orifice settings;
determining target flow data for the enclosure based on the device flow data and the predefined target pressure;
identifying an orifice setting from the one or more predefined orifice settings for performing the leakage test based on the device flow data and the target flow data; and
causing to control, using a controller, a setting of the orifice of the testing device based on the identified orifice setting for performing the leakage test.
